(19) United States
(12) Patent Application Publication
(10) Pub. No.: US 2015/0172068 A1
(43) Pub. Date: Jun. 18, 2015

(54) Network-Based Contact Broker System

(71) Applicant: Michael Kovac, Carmel, CA (US)

(72) Inventor: Michael Kovac, Carmel, CA (US)

(21) Appl. No.: 14/568,401

(22) Filed: Dec. 12, 2014

Related U.S. Application Data
(60) Provisional application No. 61/915,154, filed on Dec. 12, 2013.

(51) Int. Cl. H04L 12/18; H04L 12/58

(52) U.S. Cl. CPC H04L 12/1813; H04L 51/32

(57) ABSTRACT

A contact brokering system has a server connected to a network, the server coupled to at least one data repository and having a processor executing software (SW) from a non-transitory medium, the SW providing registration by a first user, comprising providing by the first user image and personal information, and contact information stored in the data repository and associated with the first user, generating a unique identifier for the first user, the unique identifier stored associated with the first user, adding the unique identifier to a physical object and providing that object to the first user to be deployed in a manner that a second user may access the unique identifier, and receiving at the server a communication from the second user invoking the unique identifier, and offering the second user one or more options for accessing information about the first user, or for contacting the first user.

### CROSS-REFERENCE TO RELATED DOCUMENTS

The present application claims priority to Provisional Patent Application Ser. No. 61/915,154, filed Dec. 12, 2013, and titled “Meetmyplate”. All disclosure of the referenced Provisional application is incorporated at least by reference.

### BACKGROUND OF THE INVENTION

1. Field of the Invention

The present invention in one aspect is in the field of social networking and dating sites, and pertains particularly to methods and apparatus facilitating initial contact between two individuals.

2. Discussion of the State of the Art

Dating sites are very well known in the art, and typically enable interested people to register with the site and provide personal information, including pictures and preferences. Once a member, a person may browse other members' information, and request a meeting or a date based on, usually, compatibility between characteristics and attributes of the two people.

A common problem with conventional systems is that people tend to promote themselves in the information, including pictures and other images that they provide to their personal profile. Pictures may be from earlier years, for example, or in some cases even pictures of someone else. Descriptions of personal characteristics and attributes often suffer from the same problem. As a result the person applying for a meet or a date based on the information provided by another has to invest in keeping that meet or date before having an opportunity to determine if the information the person provided is at all accurate and meaningful.

Therefore what is clearly needed is a system in which there is an opportunity to see the actual person, and perhaps observe that person in real time before applying to meet the person or setting up a date with that person.

### BRIEF SUMMARY OF THE INVENTION

In one embodiment a contact brokering system is provided, comprising a server connected to a network, the server coupled to at least one data repository and having a processor executing software (SW) from a non-transitory medium, the SW providing registration by a first user, comprising providing by the first user image and personal information, and contact information stored in the data repository and associated with the first user, generating a unique identifier for the first user, the unique identifier stored associated with the first user, adding the unique identifier to a physical object and providing that object to the first user to be deployed in a manner that a second user may access the unique identifier, and receiving at the server a communication from the second user invoking the unique identifier, and offering the second user one or more options for accessing information about the first user, or for contacting the first user.

In one embodiment the physical object is a decal enabled to be joined to a physical surface of an object, the decal having a printed rendition of the unique identifier. Also in one embodiment he printed rendition is one of a character string, a QR code or a bar code. Also in one embodiment he physical object is a template enabled to imprint the unique identifier on clothing or other cloth object. Also in one embodiment the physical object is an electronic device including digital memory with the unique identifier stored, and wherein the electronic device is enabled to transmit the unique identifier to a compatible acquisition device. In one embodiment the compatible acquisition device is a cellular telephone.

In one embodiment, upon receiving at the server a communication from the second user invoking the unique identifier, the second user is solicited to register to the service as a condition to continue. Also in one embodiment, upon receiving at the server a communication from the second user invoking the unique identifier, the second user is allowed to view at least a portion of the image and personal information associated with the first user. Still in one embodiment, upon receiving at the server a communication from the second user invoking the unique identifier, the second user is provided with a messaging mechanism to send a message to the first user. And in one embodiment, upon receiving at the server a communication from the second user invoking the unique identifier, if the second user is determined to be a registered member of the service, the first user is notified that the second user has entered the first user's unique identifier, and the first user is enabled to view at least a portion of image and personal information associated with the second user.

In another aspect of the invention a contact brokering method is provided, comprising registration by a first user at a server connected to a network, the server coupled to at least one data repository and having a processor executing software (SW) from a non-transitory medium, registration comprising providing by the first user image and personal information, and contact information stored in the data repository and associated with the first user, generating a unique identifier for the first user, the unique identifier stored associated with the first user, adding the unique identifier to a physical object and providing that physical object to the first user to be deployed in a manner that a second user may access the unique identifier, and receiving at the server a communication from the second user invoking the unique identifier, and offering the second user one or more options for accessing information about the first user, or for contacting the first user.

In one embodiment of the method the physical object is a decal enabled to be joined to a physical surface of an object, the decal having a printed rendition of the unique identifier. In one embodiment the printed rendition is one of a character string, a QR code or a bar code. In one embodiment the physical object is a template enabled to imprint the unique identifier on clothing or other cloth object. In one embodiment the physical object is an electronic device including digital memory with the unique identifier stored, and wherein the electronic device is enabled to transmit the unique identifier to a compatible acquisition device. In one embodiment the compatible acquisition device is a cellular telephone.

In one embodiment of the method, upon receiving at the server a communication from the second user invoking the unique identifier, the second user is solicited to register to the service as a condition to continue. In one embodiment, upon receiving at the server a communication from the second user invoking the unique identifier, the second user is allowed to view at least a portion of the image and personal information associated with the first user. In one embodiment, upon receiving at the server a communication from the second user invoking the unique identifier, the second user is provided with a messaging mechanism to send a message to the first user. And in one embodiment, upon receiving at the server a communication from the second user invoking the unique identifier, if the second user is determined to be a registered member of the service, the first user is notified that the second user has entered the first user's unique identifier, and the first user is enabled to view at least a portion of image and personal information associated with the second user.

### BRIEF DESCRIPTION OF THE SEVERAL VIEWS OF THE DRAWINGS

FIG. 1 is an architectural overview of a contact brokerage network according to an embodiment of the present invention.

FIG. 2 is an exemplary screen-shot of a server interface for facilitating interaction between users and the contact broker.

FIG. 3 is a block diagram depicting interaction between particular components leveraged to initiate a contact between two members.

FIG. 4 is a process flow chart depicting steps for setting up a new member according to an embodiment of the present invention.

FIG. 5 is an exemplary screen shot of a server interface according to another embodiment of the invention.

FIG. 6 is an exemplary screen shot of a server interface presenting requested member profile and contact information as a result of submitting a member number through the server interface of FIG. 5.

FIG. 7 is a block diagram depicting interaction between components leveraged to initiate contact between a member and the service according to an alternate embodiment of the invention.

FIG. 8 is a process flow chart depicting steps for registering a new object according to the alternate embodiment of FIG. 7.

### DETAILED DESCRIPTION OF THE INVENTION

In various embodiments described in enabling detail herein, the inventor provides a network-based digital contact brokerage system and methods for facilitating contact initiation between members using the system to meet. The present invention is described in enabling detail using the following examples, which may describe more than one relevant embodiment falling within the scope of the present invention.

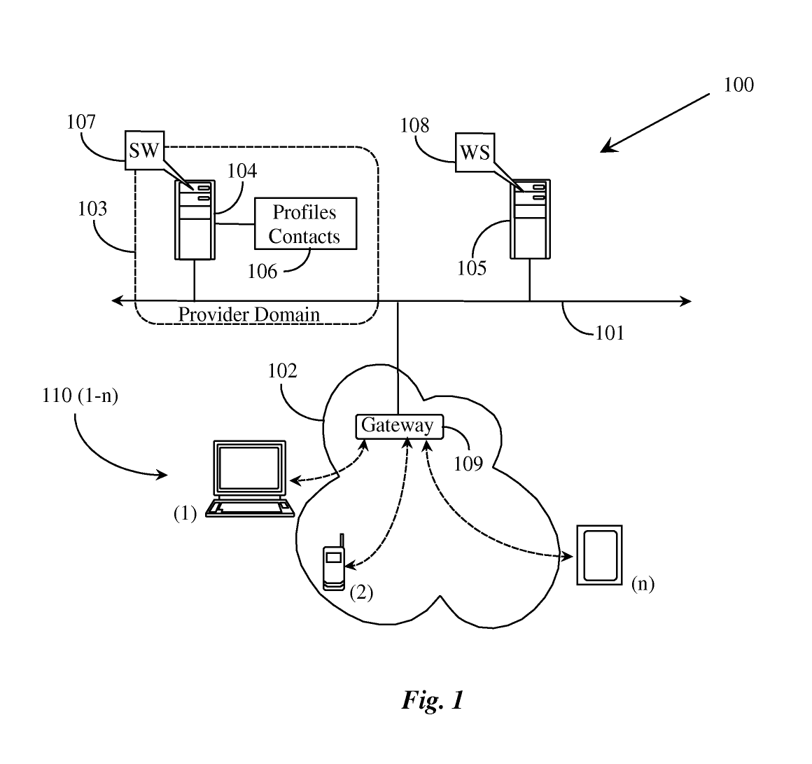

FIG. 1 is an architectural overview of a contact brokerage network 100 according to an embodiment of the present invention. Network 100 includes the Internet network depicted by a network backbone 101. Backbone 101 represents all of the lines, equipment, and access points that make the Internet network as a whole, including any connected sub-networks. Therefore there are no geographic limits to the practice of the invention. Network 100 also includes a connected sub-network 102. Network 102 is a wireless communications carrier network in this example. Network 102 may be a wired network or a combination of wired and wireless networks without departing from the spirit and scope of the present invention.

Network backbone 101 supports an Internet Web server 105. Web server 105 includes a processor with memory and at least one data repository, the memory storing all of the software and instructions required for functioning as a Web server on the network. Web server 105 hosts a Web site 108. Web site 108 may be hosted and controlled by a service provider entity depicted herein as a provider domain 103. Web site 108 represents an access point for users interested in or registered with the contact brokering system of the present invention. Users accessing Web site 108 on server 105 may be redirected to a server 104 within provider domain 103 for active contact brokering services. In one embodiment this is accomplished in the background without leaving the Web site.

Users are depicted in this example as users 110 (1-n) representing a variety of computing devices that may be used to make contact with the service and to connect with other members. User 110 (1) is using a laptop computing device. User 110 (2) is operating a cellular telephone, and user 110 (n) is using an iPad-type device for contact initiation. In this example, each device 110 (1-n) has wireless connection to a wireless Internet gateway 109 for access to servers 105 and 104. In one embodiment web server 105 is a proxy server between a member and server 104, which is more an information server.

Server 104 in provider domain 103 includes a coupled data repository 106 storing member profile data and member contact data among other data types. Server 104 also hosts software (SW) 107. SW 107 provides member registration, assigning of a unique identifier to a member, and search services for members desiring to meet other members. In one embodiment, SW 107 also has access to one or more networked printers, the printers capable of printing out decals containing a member number and/or indicia that may uniquely identify the member.

In general use of the present invention, a user, such as user 110 (n) for example, that is new to the service offered through Web site 108 may register at site 108 and may receive instruction for uploading profile data, including one or more recent photos and personal information such as likes, dislikes, education, work, hobbies, and other like data. User 110 (n) may also be prompted to upload preferred contact information such as an email address for example. Input through the web interface (server interface) on website 108 is passed over the network to server 104 in provider domain 103. Server 104 may store and correlate all of the received information about user 110 (n) into data repository 106.

Once server 104 receives the profile information and contact data, SW 107 may generate a unique number or indicia, or some combination thereof, for the new member whose information is loaded into repository 106. The number may be a 5 digit unique number in one example. SW 107 may direct that the generated number be printed on a decal or sticker. The unique identifier may be sent to a network-based printer (not illustrated) to be printed out on a decal with peel-off glue backing that may be applied and stuck to a surface of an article owned by or in control of the member for which the number was printed. In some embodiments the unique identifier may be joined to another object, such as by being embossed or stamped into a surface of an object. IN one embodiment the unique identifier may be provided on an object by such as 3D printing technology. Identifiers may thus take many forms, such as decals, key-chain fobs, indicia printed on an article of clothing, indicia provided on a purse or billfold. The purpose is that the registered user is enabled to display his or her unique identifier in a manner that other persons, some of whom may be members of the same service, may see and acquire the unique identifier. In many embodiments the identifier, or object upon which the identifier is displayed, may also display a URL or name that associates the object and/or identifier with the broker system of the present invention. The person seeing another who is identified by an object or identifier may then access the broker site and use the unique identifier to initiate contact or association with the identified member. The person acquiring the identifier is thus enabled to see the identified person in real-time, and to even observe the person over a period of time, or on repeated occasions before actually initiating contact through the broker site.

In one embodiment, third-party cloud-based printing and mailing services might be leveraged to fulfill demand for many members registering for the service on an ongoing basis. Printed decals may be mailed to members or members may be called to pick up decals at some local terminal in a participating service location. In one embodiment, a user may design and purchase one or more blank decals that might be loaded into the member's own network connected printer. In such an embodiment, the service may call the member's printer to complete the transaction and print out the member decal.

In one embodiment, the article hosting the sticker is visually accessible to the general public including other members of the service. For example, a decal with number may be applied to a window or bumper region of an automobile, on an edge of a license plate, on the back of a laptop computer, on an article of clothing in the form of a patch or iron on sticker, and other like articles that may be viewed by the public while the user is out and about.

Once a member is registered and has a decal or other object with unique number and or indicia placed on a publicly viewable article, the member may venture out with the article hosting the decal and number. In an embodiment the decal is also identifying of the service provider so that others will recognize the provider and look up the Web site to engage services. Another member may eventually be in near proximity of the advertising member and may view the decal and member number on an article owned by or controlled by the advertising member.

In this case, the observing member may also view the advertising member with respect to demeanor, looks, style, and the like before making a decision to submit the member's number to the service provider. In another case, a member might not be present when the member's decal and number are viewed by another member. For example, the member may be in a restaurant and her car hosting the decal with member number is in the parking lot. The observing member may enter the advertising member's number anyway or wait until the member comes back out to her car before deciding to initiate contact. In one embodiment, instead of a decal the number and or indicia may be printed on a magnetic base for temporary application to various articles having magnetic surfaces. In still another embodiment of a patch for clothing, the patch may be supplied with a hook and loop base for temporary application to various articles of clothing.

Once the observing person has the number visualized the observing person may record the number and upload the number through a service interface at the Web site. The observing person may log into the Web site and upload or otherwise submit the member number to the service. The number and request may be passed to server 104 for lookup of the associated member's profile and contact information held in repository 106. The number is used by the server to find the member profile information and returns the information to Web server 105 and the open session through Web site 108. The profile may include a limited set of photos and contact information. In some embodiments there may be more information like education history, employment history, lists of likes, dislikes, hobbies, etc.

The accessing person may peruse over the information and make a determination of whether to initiate contact with the advertising member. In one embodiment the only contact information served to the accessing person is a contact button that might link to a service-hosted email routing system for registered members of the service. In this case, the contacting person may not know the actual email address until the advertising member responds.

It is important to note that the accessing person may also be a member and have a member number that may be revealed to any members contacted through email. In this way the “observed” member may see the profile information of the accessing member before responding to a contact attempt by the accessing member. It is noted herein and one with skill in the art of communication brokering will appreciate that this example is just one of several possible use embodiments of the contact broker system. Other embodiments are detailed further below in this specification.

In one embodiment, upon a person who is not a member of the service accessing the site with an ID number of a member, and electing to view the member's profile information or to contact the member, that person will be solicited to become a member and to be associated with a member ID before being allowed to continue.

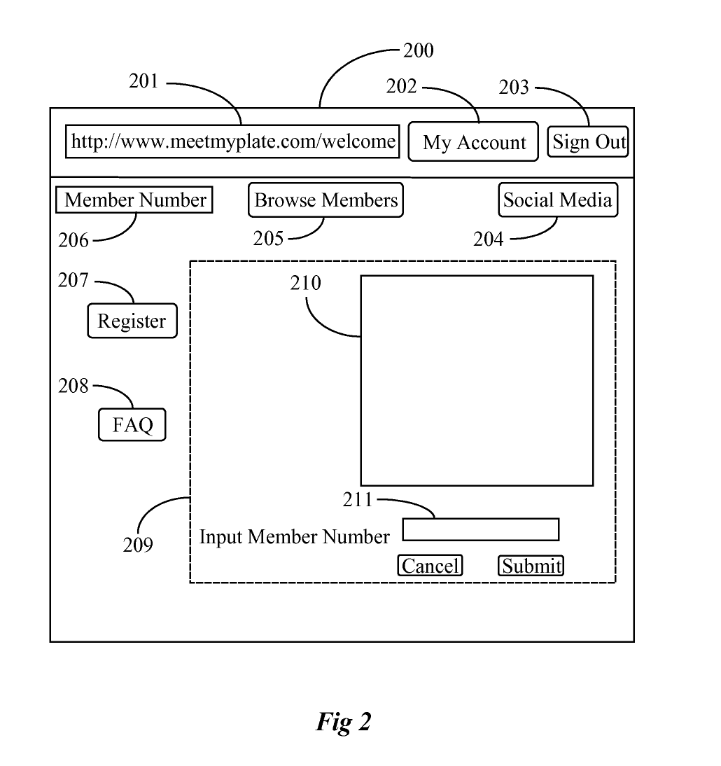

FIG. 2 is an exemplary screen-shot of a server interface 200 for facilitating interaction between users and the contact broker. Interface 200 may be a browser-based or nested interface of Web site 108 of FIG. 1, for example, the Web site. In one embodiment the Interface is integrated with SW 107 and may be served from server 104 after a proxy connection is established. Interface 200 includes a Web navigation bar 201 depicting a service provider name “meetmyplate”, know to the inventor as a potential facilitating entity hosting the service. The service may also be co-branded to other Internet based meeting or dating services, and many other names and URLs may be used.

Interface 200 in this example includes a link 202 (My Account). My account links a user to their account information, settings, and payment details. Payment for registered services may be nominal such as the costs of acquiring a number printed and mailed on a decal or other hosting medium. In this example, a user is assumed to be signed into the service. An action button 203 is provided for the user to sign out when ready. A link 204 to social media is provided for users to “like” and to follow social interaction accounts owned or controlled by the service host or provider. In one embodiment, members with social interaction pages may use all or part of their existing profiles in submitting photos and information for their new service profile when registering for the service.

Interface 200 includes a text display 206 of the member number of the signed-in member. Interface 200 includes a link 205 for browsing other members in the system. In one embodiment, members cannot be accessed without putting in a member number to access a single member. In this embodiment members might be browsed using link 205. In such a case member numbers may be revealed or they may not be revealed to a browsing user. In one embodiment only a photo or two of a member is accessible through the browse function but location might be provided of a member who gives permission to be found. This may enable a member to see where another member might frequent in public for a chance to observe the member before initiating contact.

Interface 200 includes a link 207 to register a new account. Account registration is further detailed later in this specification. Interface 200 includes a link 208 to a page of frequently asked questions (FAQ). Other references and informational summaries including testimonials, “how it works”, “why it works” and so on may be made available to visitors and members through interface 200 without departing from the spirit and scope of the present invention.

In one embodiment of the present invention, interface 200 includes an active result display window 209. Window 209 may include an interactive input field 211 for typing and submitting a user's member number. An action button to cancel and an action button for submitting the entered data may be provided within window 209. In one embodiment submission of the number causes return of at least one recent photo 210 of the member and associated text description about the member. A contact link (not illustrated) may also be provided to enable initiation of contact via email. In one embodiment more than one photo is returned and the photos may be browsed in book or slide show fashion.

In one embodiment, interface 200 is replaced by a different interface once a connection is made to the information server responsible for returning requested profile data. In this embodiment the Web site is enabled as a full service server interface once a user has logged in.

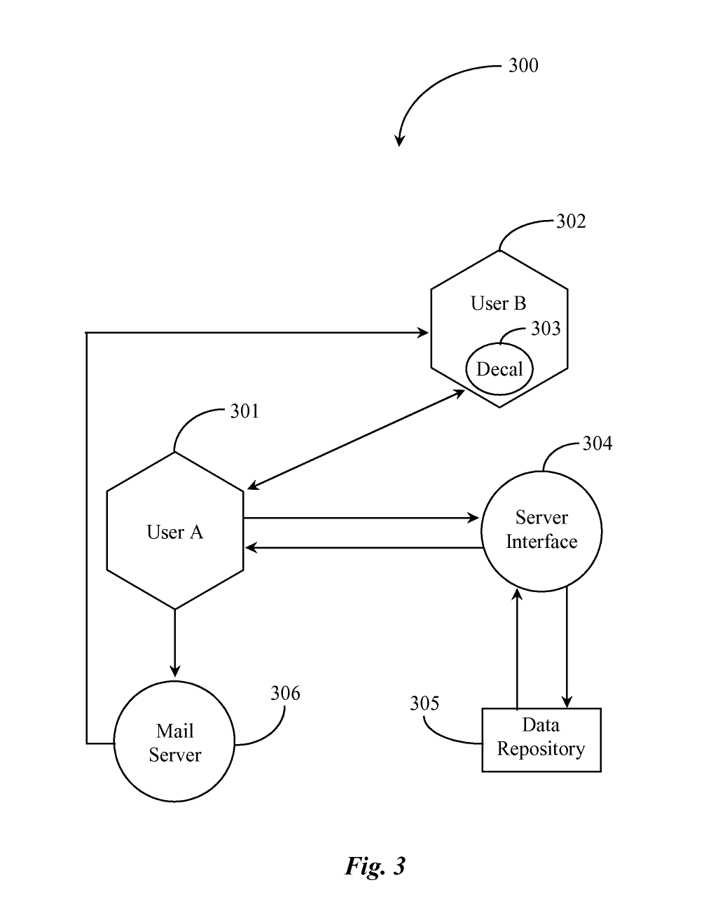

FIG. 3 is a block diagram 300 depicting interaction between particular components leveraged to initiate a contact between two members. Diagram 300 depicts a user A (301) and a user B (302). User 302 has a decal 303 with a number or indicia identifying the user as a member of the service of the present invention. Decal 303 is placed on an article belonging to or otherwise in control of the user and viewable by the public, such as a vehicle, for example.

User 301 is in near proximity to user 302 and can see decal 303 and may manually record or otherwise retain the number for submission to the service over the Internet network. User 301 may decide to use the number to obtain profile and contact information for user 302. Using a network-capable communications device or computing appliance user 301 inputs the number from the decal through a server interface 304 that may be a browser-based interface. Server interface 304 leverages the submitted number to look up the profile information of user 302 in a data repository 305.

The perhaps limited profile information including a contact link or address for user 302 is sent to user 301 through interface 304. User A may then use the contact information, such as an email address for user B, to send an email to user 302 requesting to meet user 302. In an embodiment where an email address is returned to user 301 from data repository 305, the first user may connect to a mail server 306 to send the request email. User B may determine, upon receiving the email from user A, whether or not to respond to the request. Further correspondence and whether or not a physical meeting takes place between users 301 and 302 depends upon the actions of user 302.

In one embodiment, instead of a returned email address, an interactive contact link is returned to user A through interface 304. The link may be embedded in an electronic message or web interface (server interface 304) and may not reveal any data to user 301. User 301 may activate the contact link to send a message or to initiate a voice call back, or some other communication in which user B may determine to engage in or not. In this embodiment, the message routing system and user interfaces may be provided by the service provider in a way that the actual contact information is not available to the requesting users.

In the embodiment just described, if user 302 rejects or fails to respond to the request to communicate from user 301, the information (decal data) may be withdrawn from use by user 301 so that it may not be used again by that user to attempt to contact user 302. In this way, harassing, or otherwise continually attempting to contact a user who has declined to respond, may be prevented. In one embodiment a voice contact link may be returned to a submitting user in place of a messaging contact link. For example, the requesting user might activate a call-back link through interface 304, submit a telephone number, and user 302 may upon receiving the request with number, and determine whether or not to place a call to the requesting user.

In one embodiment of the present invention, any request received by a targeted user (user 302) may automatically include access to the profile data of the requesting user including at least one photo so that user 302 might have an idea about user 301 before calling back or returning a message request.

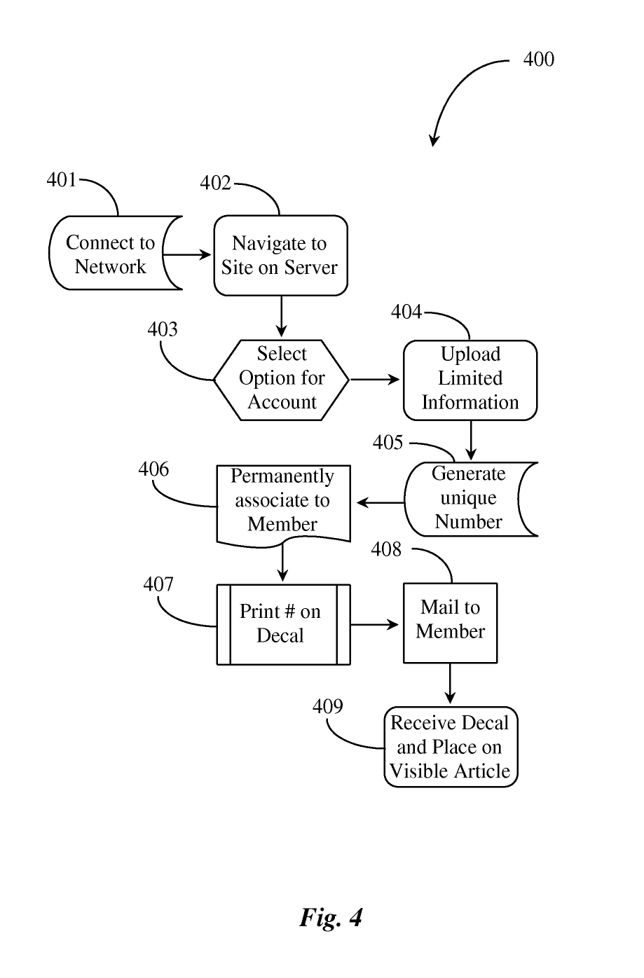

FIG. 4 is a process flow chart 400 depicting steps for setting up a new member according to an embodiment of the present invention. A user wishing to engage in the service of the present invention may connect to the Internet network and navigate to the service site generally available through a Web page hosted on a network server.

Once on the Website, the interested user may select a presented option (link) for registering and setting up a new account. The user may, upon prompt from the service, upload a limited amount of information to the server to form a user profile in step 404. This data may minimally include one to several recent photos and at least one contact address or number used to initiate possible communication between the new user and a requesting user. The system aided by SW may generate a new unique number and or indicia for the new user at step 405. At step 406 the number and or indicia may be permanently assigned to the new user.

The assigned number and or indicia may contain a series of numbers large enough to be visually retained by persons in close proximity of display of the numbers. Indicia that readily identifies the service provider may also be provided. In one embodiment the decal takes on characteristics or a unique shape that readily defines the particular service provider hosting the service and that may be proprietary information protected against use by other entities. Such indicia might be a bright logo created for unique identification purposes. In this embodiment the member identification is printed on one or more decals for the new user. The decals may be mailed to the new user for application to personal articles at step 408.

In other embodiments, other methods might be employed to get decals to new users. In one alternative embodiment, a new user may pick up one or more special decals at a retail establishment such as at an electronics outlet, for example. The user may then navigate to the Website and register, upon which the assigned member number may be printed on one or more purchased decals at the new user's location on a network-connected printer controlled by the user. In another embodiment the decals may be printed at a participating local business and the new member may be contacted to come and pick up the decal(s). Once the decal(s) are received or otherwise obtained by the new member, the new member may place it or them on one or more articles owned by or otherwise controlled by the new member at step 409.

It is noted herein that the embodiment of a decal with data printed thereon shall not be construed as a limitation of the present invention. Other method of propagating member identification for public display might be practiced such as putting the information on a patch that might be sewn on to or ironed onto an article of clothing. Still another method may be putting the information on a large button to be pinned to an article of clothing. Still another method may be to place the information on a sheet magnet or magnetic decal that might be placed temporarily on a magnetic article to be removed when not being used (user not advertising). In one embodiment a combination of the above methods and apparatus might be used with exact combination determined by the customers in personalized fashion. There are many variant possibilities.

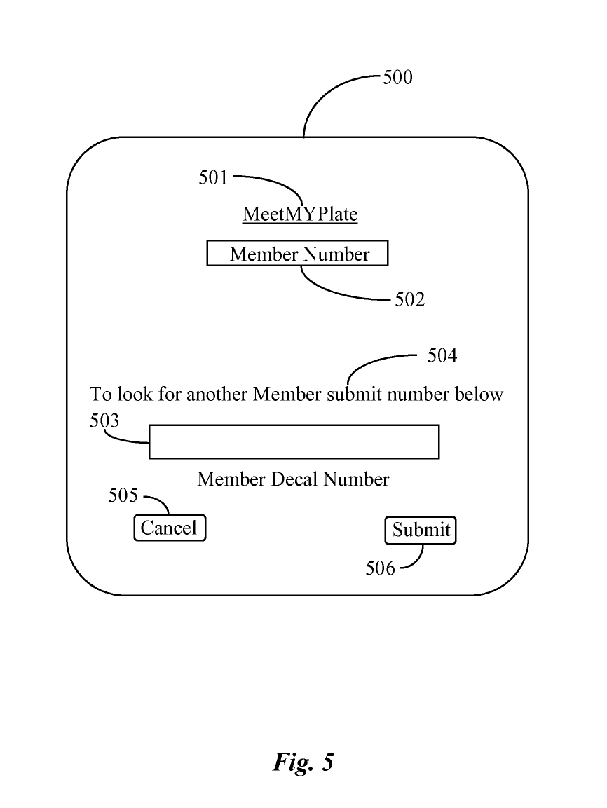

FIG. 5 is an exemplary screen shot of a server interface 500 according to another embodiment of the invention. In this embodiment, interface 500 is a light mobile interface for display on a small screen such as on a mobile phone. Interface 500 may be limited as far as the inclusion of presented data on first access to a service provider logo 501, in this instance, “MeetMyPlate”, a display 502 of the member number of the accessing user, and a text field 503 for input of a member's number belonging to a user witnessed by the accessing user. Interface 500 may be voice activated in some embodiments. In this example, a cancel operation button 505 and a data submission button 506 are provided in conjunction with the input field 503. Submission of a member's insignia or number through interface text field 503 begs a response from the service containing some photos and contact data (actual or proxied).

In one embodiment, a member number may also be authentication data for that user to practice the service of the invention.

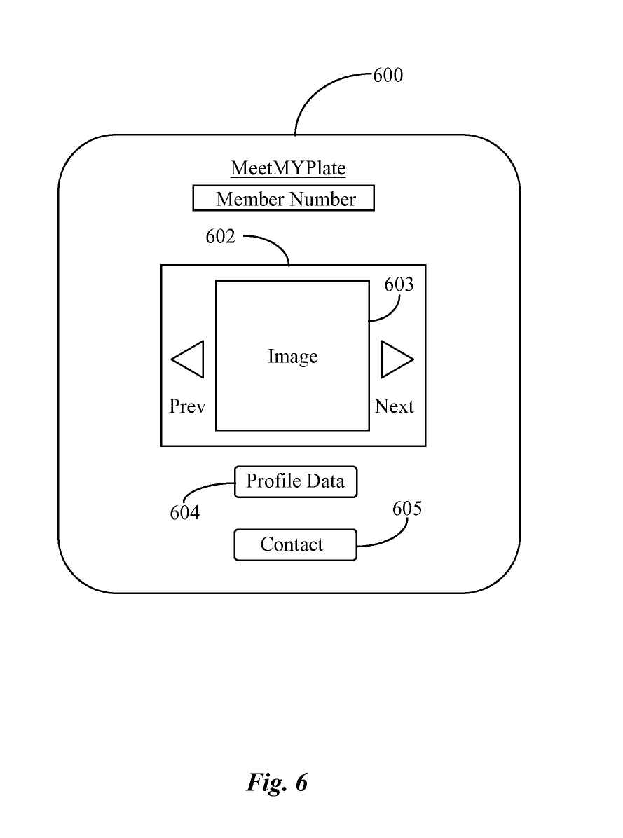

FIG. 6 is an exemplary screen shot of a server interface 600 presenting requested member profiles and contact information as a result of submitting a member number through the server interface of FIG. 5. Interface 600 may include a display window 602 containing one or more images such as image 603. There may be one or more than one profile image returned and in the case of more than one a slide show of the images may be enabled such that the accessing user may scroll through and view such images.

In one embodiment interface 600 includes an active link 604 to more profile data of the advertising user. The additional profile data may be a link to an “off-site” profile like a social interaction page profile. In this example, clicking on profile data 604 returns text information about the advertising user such as education, employment information, likes, dislikes, hobby information, favorite music, and so on. This data may be highly personalized by the advertising user, giving access to user-approved information only.

Interface 600 includes a contact link 605. Execution of contact link 605 may cause display of a call-back interface with a text field for the accessing user to enter a call back number for the advertising user to call. In one embodiment contact link 605 accesses a central message routing system hosted by the service provider that only serves members of the service of the present invention. In this way initiating contact with an advertising member is facilitated without overloading the interface or adding too much information to the system.

It is noted herein that the Website might also have a functional sub interface for submitting member number to look up existing members. An interface such as interface 500 of FIG. 5 and interface 600 may be embedded into a social interaction page or some other interface frequently accessed by the user. An advertising user may advertise their member number in a variety of different ways by placing decals on various different articles such as on a Lap top used in a wireless fidelity (WiFi) hotspot. Member numbers might be placed on a license plate, a car window, a car door, an article of clothing, on a bicycle, a motorcycle, a boat, or on any other article owned by or otherwise controlled by the advertising user.

In one embodiment, any user may block any other user by preventing the service from looking up and returning data when a blocked user attempts to use the member's number to access information. After correspondence has occurred between users, a user may still be blocked if the advertising user determines no further correspondence is desired with a particular accessing user. In this case, the contact information may be transparent to accessing users so that once they are blocked they will not retain any actual contact information from the blocking user.

If actual contact information was shared with a blocked user through previous interaction, then the advertising user may configure to block the accessing user through the programs facilitating the contact sessions such as an email or messaging program. In one embodiment if a user becomes inactive for a period, the service might retain their number, profile, and contact information in anticipation of the user reactivating their account.

### Registering of Objects

In an alternative aspect of the invention an object perhaps embodying some level of intrigue or importance that may be viewed by the public might be registered with a service of the invention, the object or other physical entity receiving a unique code printable or otherwise displayable on the object or on a sticker placed on or otherwise associated with the object being registered. The code may be machine-readable and may be scanned using a mobile telephone with a scanning application for example, to retrieve information about the object over the network. In this aspect the code may be a bar code or a QR code. Object information might include object description, object history, and perhaps identification and contact data for other members that have handled, studied, or otherwise may have been connected to or associated with the object in some way. The returned data might additionally include active links to other documents related to the object or documented work performed because of the object. Data in a data repository at the service may also be networked and inter-associated in many ways. As a single example, a user may register a vintage musical instrument, a guitar, for example, once owned and used by Willie Nelson. That guitar will be associated in the data repository with the new owner of the guitar, likely the person registering the guitar. It may also be associated with extensive data about Willie Nelson, relating, for example, to concerts where Willie Nelson used that guitar. Associations may also be made to similar guitars (perhaps the same make or type) owned or used by others. Intricate relationships between persons and objects and other persons and other objects, replete with stories and histories, may be made.

In some cases the relationships and stories and other data may be entered by a user. In other cases the system itself may automatically search and expand the relationships, and incorporate already-existing stories and other data. And in some cases both methods may be used.

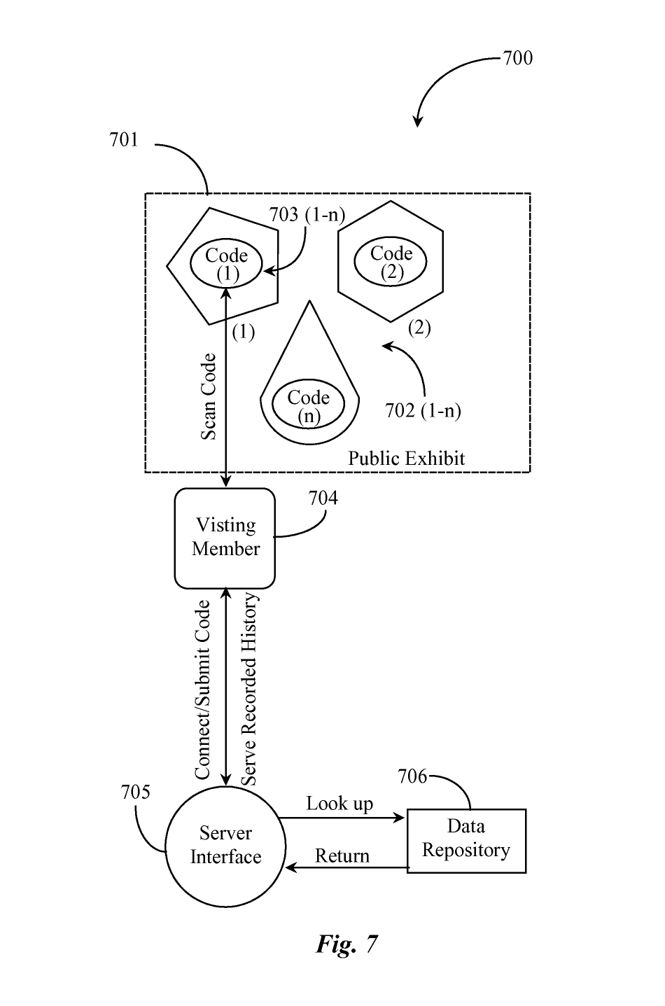

FIG. 7 is a block diagram 700 depicting interaction between components leveraged to initiate contact between a member and the service according to the alternative aspects of the invention mentioned above. In this example of an embodiment of the present invention, one or more objects 702 (1-n) may be presented or displayed in a public exhibit for example, public exhibit 701 (bounded by broken rectangle). Exhibit 701 may be a table with artifacts, a shelf of products, a marked area of geography containing the objects, etc.

In this embodiment an object such as object 702 (1) may be registered with the service of the present invention by an authorized person such as a curator of the object or someone otherwise responsible for or connected to the object. A machine-readable code may be generated and assigned to each object 702 (1-n) under registration, the code printed on a sticker, decal, or other implement (703 (1-n) that may be placed on or in association with an object in a state of public display.

An individual visiting display 701, for example, a visiting member 704, may scan the code of an object such as on or associated with decal 703 (1) placed on object 702 (1), using, for example, a mobile phone with image-capturing ability. Visiting member 704 might be required to be a member of the service before they can practice information retrieval. In one embodiment, any member of the public having a device with network navigation and scanning capabilities such as member 704 may scan in the object code, for example, object code 703 (1) from decal or sticker 702 (1).

In one embodiment the visiting member is a member of the service of the present invention and has a member number as described previously above in this specification. In one embodiment, visiting member 704 is a general member of the public and does not require membership with the service in order to participate.

Very much like the process described above for initiating contact between two users, visiting member 704 may connect to a network once the code has been scanned into a device. Once on the network, the member may navigate to a service site or the code may include automated access to a web service site to access a server interface 705. Server interface 705 may include an upload function to facilitate upload of the scanned image document representing the scanned code. Once the scanned code is submitted to the service by visitor 704 the server uses the code and any other associated data to look up the object data in a data repository such as repository 706.

The server may return the object information through the interface to the accessing visitor. The data may include object history, object description, identification of previous object locations, identification of previous object owners or curators, and a variety of other information about the object. In addition to object information (object profile), the returned data may include one or more contact links to any of or all of the individuals that have or had something important relationship with the object. The object might be a piece of art and users connected to it might be restorers of the art and the discoverer of the art. Other data connected to the art might include the artist, an association the artist or to whom the object belongs, and so on.

In one use case, the object might be, for example, a museum artifact connected to previous locations and curators tracked back to the discovery of the object in the field. A connected user might be a student who discovered the object. Objects may be related in some way such as being individual paintings of a set of paintings, or individual bone types of a dinosaur skeleton, etc. There are many, many possibilities. Objects may be traded with each trade and party involved in the trade documented and added to available information about the object.

In one aspect a user that owns a coded object might be interested in who owns other existing copies or originals of the same object that make up a set of the objects such as a series of painting by a same artist, or a collection of compact discs of a same musician band or composer. In one aspect, the object might be a virtual object or a copy of a real object held in seclusion or not generally available for public viewing. Members or public visitors such as member 704 may access rich information and may initiate contact with various entities that have been associated with the object in question in some noteworthy way.

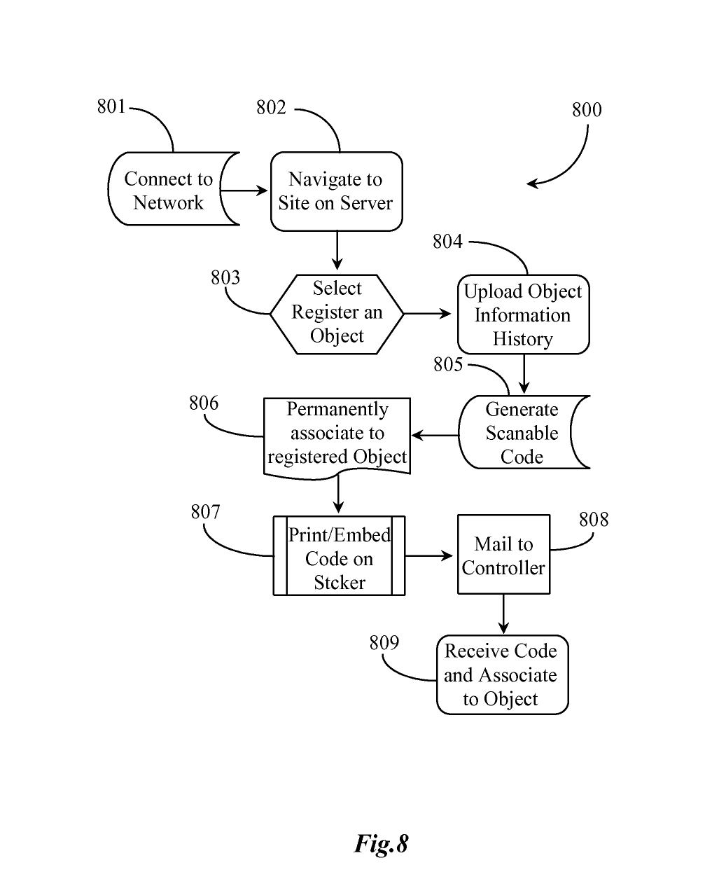

FIG. 8 is a process flow chart 800 depicting steps for registering a new object according to the alternative embodiment of FIG. 7. At step 801 a curator or other individual currently charged with registering an object like one of objects 702 (1-n) connects to a network such as the Internet network. At step 802 the user may navigate to a server hosting the service. Through an available interface, the user may select a presented option for registering a new object.

The user may then be prompted to upload information about the object including object description, history, and information about societies and other individuals associated with the object as part of the object's record. In one embodiment, information about the object may be continually or periodically added to the system as such information is revealed or discovered, such as the existence of a like object already registered and sharing characteristics with the new object being registered. In this case information already in the system that may be associated with other registered objects may be applied to the information of the new object to reduce redundancy.

Like the process described earlier with reference to flow chart 400 of FIG. 4 for registering an individual user, the system may generate a unique number or code for the new object in step 805. In step 806 the system may permanently associate the code to the object being registered. In step 807, the code may be printed on a sticker or decal that will be placed on the object or otherwise associated with the object in display. The sticker or decal may be mailed to the controller of the object such as the current object curator at step 808.

Other methods of getting the decal or sticker with code to the controller might be used as described further above relative to flow chart 400. At step 809, the curator or controller may receive the code on a sticker or decal and place it or otherwise associate with the object in display so that it might be scanned by visitors.

In one embodiment, the unique number, indicia, code or a combination thereof might associate social data, photos, stories, articles, and or past experiences to a license plate or vehicle identification number (VIN) number of a car. A user might be able to enter the unique code into a web or mobile application and see the social history of the automobile. Object codes may be scanned such as a bar code, a quick response (QR) code, etc. The scan might be performed by any capable device including a mobile phone.

In one embodiment an object might be a bench, a seat in a stadium, or other fixed location hosting the object in a fixed position. The code of the object in this case may provide information about actions that object has “witnessed”. For a stadium seat, for example, a home run may have landed there. A dignitary might have sat there for an event.

It will be apparent to one with skill in the art that the contact brokering system of the invention may be provided using some or all of the mentioned features and components without departing from the spirit and scope of the present invention. It will also be apparent to the skilled artisan that the embodiments described above are specific examples of a single broader invention that may have greater scope than any of the singular descriptions taught. There may be many alterations made in the descriptions without departing from the spirit and scope of the present invention.

In some embodiments of the inventions enabled in this specification the identifying mechanism may be other than an indicia or member number. In some cases electronic devices, similar to the chips used in pet identification, may be used, and a member's mobile device may be enabled to connect to the electronic chip wirelessly, or by contact, and to retrieve the unique ID, and use that ID to access data in the network, such as the website of a service according to an embodiment of the invention. In this aspect the service in an embodiment of the invention, when a new person or object is registered, may assign a unique ID, and that ID may be encoded in an electronic device rather than printed on a decal or the like, or both. The electronic devices may be provided in many different forms that may be added to or embedded in objects.

It will also be apparent to the skilled person that the arrangement of elements and functionality for the invention is described in different embodiments in which each is exemplary of an implementation of the invention. These exemplary descriptions do not preclude other implementations and use cases not described in detail. The elements and functions may vary, as there are a variety of ways the hardware may be implemented and in which the software may be provided within the scope of the invention. The invention is limited only by the breadth of the claims below.

1. A contact brokering system, comprising:
a server connected to a network, the server coupled to at least one data repository and having a processor executing software (SW) from a non-transitory medium, the SW providing:
registration by a first user, comprising providing by the first user image and personal information, and contact information stored in the data repository and associated with the first user;
generating a unique identifier for the first user, the unique identifier stored associated with the first user;
adding the unique identifier to a physical object and providing that object to the first user to be deployed in a manner that a second user may access the unique identifier; and
receiving at the server a communication from the second user invoking the unique identifier, and offering the second user one or more options for accessing information about the first user, or for contacting the first user.

2. The contact brokering system of claim 1 wherein the physical object is a decal enabled to be joined to a physical surface of an object, the decal having a printed rendition of the unique identifier.

3. The contact brokering system of claim 2 wherein the printed rendition is one of a character string, a QR code or a bar code.

4. The contact brokering system of claim 2 wherein the physical object is a template enabled to imprint the unique identifier on clothing or other cloth object.

5. The contact brokering system of claim 2 wherein the physical object is an electronic device including digital memory with the unique identifier stored, and wherein the electronic device is enabled to transmit the unique identifier to a compatible acquisition device.

6. The contact brokering system of claim 5 wherein the compatible acquisition device is a cellular telephone.

7. The contact brokering system of claim 1 wherein, upon receiving at the server a communication from the second user invoking the unique identifier, the second user is solicited to register to the service as a condition to continue.

8. The contact brokering system of claim 1 wherein, upon receiving at the server a communication from the second user invoking the unique identifier, the second user is allowed to view at least a portion of the image and personal information associated with the first user.

9. The contact brokering system of claim 1 wherein, upon receiving at the server a communication from the second user invoking the unique identifier, the second user is provided with a messaging mechanism to send a message to the first user.

10. The contact brokering system of claim 1 wherein, upon receiving at the server a communication from the second user invoking the unique identifier, if the second user is determined to be a registered member of the service, the first user is notified that the second user has entered the first user's unique identifier, and the first user is enabled to view at least a portion of image and personal information associated with the second user.

11. A contact brokering method, comprising:
registration by a first user at a server connected to a network, the server coupled to at least one data repository and having a processor executing software (SW) from a non-transitory medium, registration comprising providing by the first user image and personal information, and contact information stored in the data repository and associated with the first user;
generating a unique identifier for the first user, the unique identifier stored associated with the first user;
adding the unique identifier to a physical object and providing that physical object to the first user to be deployed in a manner that a second user may access the unique identifier; and
receiving at the server a communication from the second user invoking the unique identifier, and offering the second user one or more options for accessing information about the first user, or for contacting the first user.

12. The contact brokering method of claim 11 wherein the physical object is a decal enabled to be joined to a physical surface of an object, the decal having a printed rendition of the unique identifier.

13. The contact brokering method of claim 12 wherein the printed rendition is one of a character string, a QR code or a bar code.

14. The contact brokering method of claim 12 wherein the physical object is a template enabled to imprint the unique identifier on clothing or other cloth object.

15. The contact brokering method of claim 12 wherein the physical object is an electronic device including digital memory with the unique identifier stored, and wherein the electronic device is enabled to transmit the unique identifier to a compatible acquisition device.

16. The contact brokering method of claim 15 wherein the compatible acquisition device is a cellular telephone.

17. The contact brokering method of claim 11 wherein, upon receiving at the server a communication from the second user invoking the unique identifier, the second user is solicited to register to the service as a condition to continue.

18. The contact brokering method of claim 11 wherein, upon receiving at the server a communication from the second user invoking the unique identifier, the second user is allowed to view at least a portion of the image and personal information associated with the first user.

19. The contact brokering method of claim 11 wherein, upon receiving at the server a communication from the second user invoking the unique identifier, the second user is provided with a messaging mechanism to send a message to the first user.

20. The contact brokering method of claim 11 wherein, upon receiving at the server a communication from the second user invoking the unique identifier, if the second user is determined to be a registered member of the service, the first user is notified that the second user has entered the first user's unique identifier, and the first user is enabled to view at least a portion of image and personal information associated with the second user.
